(19) United States
(12) Patent Application Publication
(10) Pub. No.: US 2023/0266133 A1
(43) Pub. Date: Aug. 24, 2023

(54) INFORMATION PROCESSING APPARATUS, MOVING OBJECT, SERVER, AND METHOD

(71) Applicant: HONDA MOTOR CO.,LTD., Tokyo (JP)

(72) Inventors: Moriya HORIUCHI, Saitama (JP); Yuta SAKAGAWA, Saitama (JP); Takahiro KUREHASHI, Saitama (JP)

(21) Appl. No.: 18/060,565

(22) Filed: Nov. 30, 2022

(30) Foreign Application Priority Data
Feb. 18, 2022 (JP) 2022-023798

(51) Int. Cl. G01C 21/34; G08G 1/01

(52) U.S. Cl. CPC G01C 21/3461; G08G 1/0133

(57) ABSTRACT

An information processing apparatus includes: a risk area identification unit configured to identify a risk area outside a moving object; a transmission control unit configured to control sending risk area information indicating the risk area identified by the risk area identification unit to a server for retaining information indicating a risk area; and a reception control unit configured to control receiving the information indicating the risk area retained in the server in relation to a planned traveling route of the moving object, wherein the transmission control unit is configured to control sending evaluation information regarding evaluation of the risk area indicated by the information received from the server when the risk area identification unit could not identify, on the planned traveling route, the risk area indicated by the information received from the server.

The contents of the following Japanese patent application(s) are incorporated herein by reference:
NO. 2022-023798 filed on Feb. 18, 2022.

### BACKGROUND

### 1. Technical Field

The present invention relates to an information processing apparatus, a moving object, a server, and a method.

### 2. Related Art

In recent years, efforts have been intensified to provide access to sustainable transportation system with consideration given to even vulnerable people among other traffic participants. To this end, research and development has been focused on to further improve traffic safety and convenience through research and development regarding preventive safety technology. Patent Document 1 describes that information is sent, to an external information collecting apparatus, regarding a risk area judged by an information processing apparatus provided in a vehicle.

### PRIOR ART DOCUMENT

Patent Document 1: Japanese Patent Application Publication No. 2021-140470

### BRIEF DESCRIPTION OF THE DRAWINGS

FIG. 1 schematically shows a usage scene of a system 10.

FIG. 2 shows a scene in which the vehicle 20g has approached an area 110 and an area 120.

FIG. 3 shows a system configuration of a vehicle 20.

FIG. 4 shows a system configuration of a server 52.

FIG. 5 conceptually shows position information of a risk area managed by an information processing apparatus 24a.

FIG. 6 shows, in a table form, a data structure of risk area management information retained by a retention unit 340.

FIG. 7 schematically shows a flow of processing executed by a vehicle 20a, the vehicle 20g, a vehicle 20h, and the server 52.

FIG. 8 is a flowchart showing a processing procedure executed by an information processing apparatus 24 of the vehicle 20.

FIG. 9 is a flowchart showing a processing procedure executed by the server 52.

FIG. 10 shows an example of a computer 2000 in which a plurality of embodiments of the present invention may be entirely or partly embodied.

### DESCRIPTION OF EXEMPLARY EMBODIMENTS

Hereinafter, the present invention will be described through embodiments of the invention, but the following embodiments do not limit the claimed invention. Also, not all combinations of features described in the embodiments are necessary to the solution of the invention.

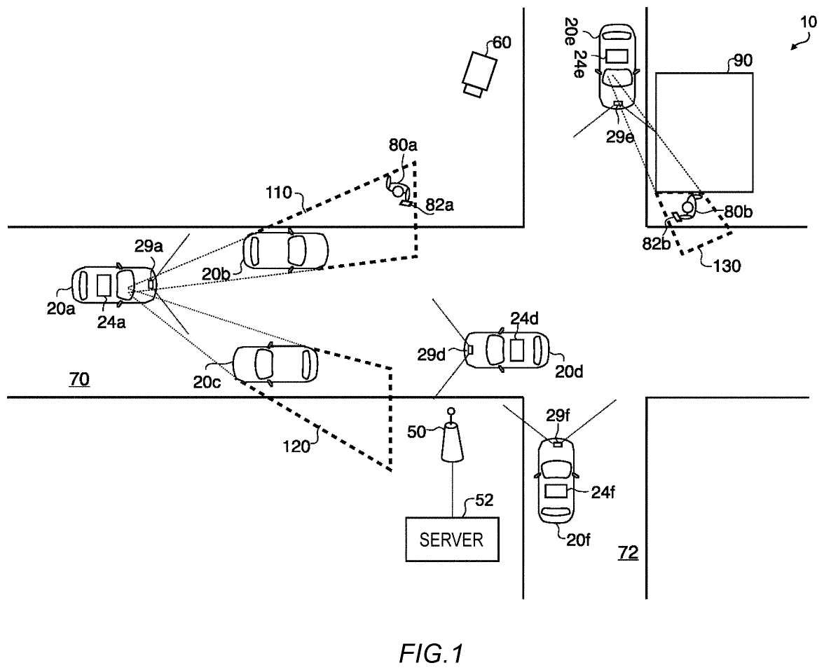

FIG. 1 schematically shows a usage scene of a system 10. The system 10 includes: a vehicle 20a, a vehicle 20b, a vehicle 20c, a vehicle 20d, a vehicle 20e, and a vehicle 20f; a terminal 82a and a terminal 82b; a base station 50; a server 52; and a camera system 60.

In this embodiment, the vehicle 20a, the vehicle 20b, the vehicle 20c, the vehicle 20d, the vehicle 20e, and the vehicle 20f may be collectively referred to as “vehicle(s) 20”. The vehicle 20 is one example of a moving object. Also, the terminal 82a and the terminal 82b are respectively possessed by a pedestrian 80a and a pedestrian 80b. In this embodiment, the pedestrian 80a and the pedestrian 80b may be collectively referred to as “pedestrian 80”. Also, the terminals 82a and 82b may be collectively referred to as “terminal 82”.

The terminal 82 is a mobile terminal such as, for example, a smartphone. The base station 50 is for mobile communication. The server 52 is connected to the base station 50. The server 52 may include an edge computing server such as, for example, a MEC server.

The camera system 60 is provided in an infrastructure. The camera system 60 has an image-capturing function, an image recognition function, and a communication function. The camera system 60 recognizes a captured image, and recognizes position information of a predetermined target such as a pedestrian 80 from the image. The camera system 60 is used as a camera that collects information for the purpose of vehicle travel assistance.

The vehicle 20a includes a sensor 29a and an information processing apparatus 24a. The sensor 29a is constituted by including a camera. The information processing apparatus 24a includes a function to process information acquired by the sensor 29a, and a communication function. It should be noted that, in this embodiment, by adding one of suffixes (“a”, “e”, “f”, or the like) of reference numerals of the vehicle 20 as a suffix of a reference numeral of a component (for example, a sensor 29 and an information processing apparatus 24) provided in the vehicle 20, it may be distinguished which of the vehicles 20 includes the component.

In FIG. 1, the vehicle 20a is traveling along a road 70. The vehicle 20b is parked on the road 70. For the vehicle 20a, an area 110 on an advancing direction side of the vehicle 20a with respect to the parked vehicle 20b, is hardly recognized visually from the position of the vehicle 20a. Also, the vehicle 20c is traveling along an oncoming lane of the road 70 when viewed from the vehicle 20a. An area 120 on the advancing direction side of the vehicle 20a with respect to the vehicle 20c, is hardly recognized visually from the position of the vehicle 20a. Therefore, the information processing apparatus 24a detects, from an image of the advancing direction acquired by the sensor 29a, the area 110 and the area 120 invisible from the vehicle 20a as risk areas. The information processing apparatus 24a sends risk area information including position information of the areas 110 and 120 by wireless communication.

In FIG. 1, the vehicle 20d is an oncoming vehicle for the vehicle 20a, and is traveling at a position from which the area 110 and the area 120 can be visually recognized. When receiving the risk area information sent from the vehicle 20a, the information processing apparatus 24d of the vehicle 20d determines whether a pedestrian is present in each of the area 110 and the area 120 from an image acquired by a sensor 29d. When detecting presence of the pedestrian 80a in the area 110 from the image acquired by the sensor 29d, the information processing apparatus 24d sends information indicating presence of a pedestrian in the area 110 to the vehicle 20a by wireless communication.

When receiving the risk area information sent from the vehicle 20a, the terminal 82a determines whether a current position of the terminal 82a is within the area 110. When determining that the current position of the terminal 82a is within the area 110, the terminal 82a sends response information indicating presence of the terminal 82a in the area 110 to the vehicle 20a by wireless communication. Also, the terminal 82a outputs alarm information to the pedestrian 80a.

When receiving the risk area information sent from the vehicle 20a by the communication function, the camera system 60 detects a position of the pedestrian 80a in the area 110 from an image acquired by the image-capturing function. The camera system 60 sends the information indicating presence of a pedestrian in the area 110 to the vehicle 20a by wireless communication.

In the vehicle 20a, the information processing apparatus 24a displays an alarm when receiving the information indicating presence of a pedestrian in the area 110 from one of the vehicle 20d, the camera system 60, and the terminal 82a. Also, when receiving the response information from the terminal 82a, the information processing apparatus 24a displays an alarm to an occupant of the vehicle 20a.

It should be noted that, in FIG. 1, an area 130 is hardly recognized visually, for example, from a position of the vehicle 20e traveling on a road 72, because a building 90 obstructs vision. Consequently, the information processing apparatus 24e of the vehicle 20e judges the area 130 as a risk area, and sends risk area information including position information of the area 130 by wireless communication.

In FIG. 1, the vehicle 20f is an oncoming vehicle for the vehicle 20e, and is stopped at a position from which the area 130 can be visually recognized. When receiving the risk area information sent from the vehicle 20e, the information processing apparatus 24f of the vehicle 20f determines whether a pedestrian is present in the area 130 from an image acquired by a sensor 29f. When detecting presence of the pedestrian 80b in the area 110 from the image acquired by the sensor 29f, the information processing apparatus 24f sends response information indicating presence of a pedestrian in the area 130 to the vehicle 20e by wireless communication. Also, when receiving the risk area information, the terminal 82b determines whether a current position of the terminal 82b is within the area 130, and when determining that the current position is within the area 130, the terminal 82b sends response information indicating presence of the terminal 82b in the area 130 to the vehicle 20e by wireless communication. Also, the terminal 82b outputs alarm information to the pedestrian 80b.

In the vehicle 20e, the information processing apparatus 24e displays an alarm when receiving the response information indicating presence of a pedestrian in the area 130 from the vehicle 20f. Also, when receiving the response information from the terminal 82b, the information processing apparatus 24e displays an alarm to an occupant of the vehicle 20e.

Thus, the information processing apparatus 24 judges, as a risk area, an invisible area that is a sort of a blind spot of its own vehicle, and sends risk area information including position information of the risk area to another vehicle by wireless communication. When receiving the risk area information, the other vehicle determines whether a pedestrian is present in that risk area, and sends response information indicating presence of a pedestrian in that risk area by wireless communication. Also, the terminal 82 sends response information by wireless communication when the terminal is present within that risk area. When receiving the response information from the pedestrian's terminal 82 or the other vehicle, the information processing apparatus 24 displays an alarm to an occupant of the vehicle 20. This allows an appropriate report on a risk area that cannot be recognized by the vehicle 20 or the pedestrian 80. The risk area refers to recognition of a state regarding an external environment recognized by the vehicle 20 or the information processing apparatus 24. The risk area may be, for example, an area that poses a risk to the pedestrian 80 or the vehicle 20. The risk area may be, for example, an area whose safety needs to be confirmed by the pedestrian 80 or the vehicle 20.

When receiving position information of the area 110 and position information of the area 120 sent from the information processing apparatus 24a of the vehicle 20a, the server 52 retains the received position information of the area 110 and the area 120. Also, when receiving position information of the area 130 sent from the information processing apparatus 24e of the vehicle 20e, it retains the position information of the area 130. Then, the server 52 sends the retained position information of the area 110 and the area 120, for example, in response to a request from a vehicle following the vehicle 20a. Also, the server 52 sends the retained position information of the area 130, for example, in response to a request from a vehicle following the vehicle 20e. According to the system 10, risk areas identified in a plurality of vehicles 20 can be shared with one another to give a warning.

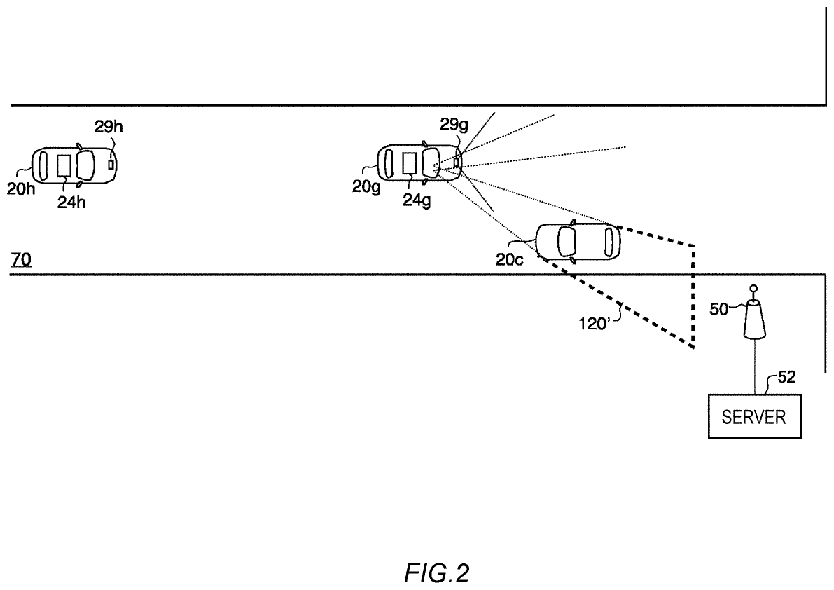

FIG. 2 shows a scene in which the vehicle 20g has approached the area 110 and the area 120. The vehicle 20g is a vehicle that was traveling behind the vehicle 20a. The vehicle 20g includes an information processing apparatus 24g and a sensor 29g. The information processing apparatus 24g requests the server 52 for a risk area on a planned traveling route of the vehicle 20g, and receives the position information of the area 110 and the position information of the area 120 from the server 52.

The information processing apparatus 24g identifies an area 120′ as a risk area based on information detected by the sensor 29g. As described in relation to FIG. 1, the information processing apparatus 24g sends risk area information including position information of the area 120′ by wireless communication.

As shown in FIG. 2, since the vehicle 20b is not present when the vehicle 20g passes near the area 110, the information processing apparatus 24g cannot identify a risk area at a position indicated by the position information of the area 110 received from the server 52. Consequently, the information processing apparatus 24g sends, to the server 52, evaluation information indicating that the risk area could not be identified at the position corresponding to the area 110. When receiving the evaluation information of the area 110 from the vehicle 20g, the server 52 decreases an evaluation value of the area 110 as the risk area.

As shown in FIG. 2, when having approached the area 110, a vehicle 20h, which is following the vehicle 20g, performs similar processing to the vehicle 20g, and sends evaluation information regarding the area 110 to the server 52. This may decreases the evaluation value of the area 110 retained by the server 52. The server 52 decreases the evaluation value of the area 110 as the risk area each time it receives the evaluation information of the area 110 from each of the vehicles 20, and if the evaluation value has become less than a predetermined threshold value, the server 52 deletes the area 110 retained as the risk area. This allows provision of highly reliable risk area information.

It should be noted that the information processing apparatus 24g can identify the area 120′ at a position corresponding to the position information of the area 120 received from the server 52. Consequently, the information processing apparatus 24g does not send evaluation information of the risk area to the server 52. Therefore, the server 52 does not decrease an evaluation value of the area 120, and continues to retain the area 110 as the risk area.

It should be noted that communication between the information processing apparatus 24 of a vehicle 20, and the terminal 82 and the information processing apparatus 24 of another vehicle 20 is executed by direct communication. For example, the information processing apparatus 24 of a vehicle 20 directly communicates with the terminal 82 and the information processing apparatus 24 of another vehicle 20 by short-range direct communication in Cellular-V2X. Short-range direct communication in Cellular-V2X includes a communication scheme such as LTE-V2X PC5 or 5G-V2X PC5 (abbreviated as “PC5” in this embodiment). A form may be adopted in which Wi-Fi (registered trademark) or Dedicated Short Range Communications (DSRC) is used as direct communication. The information processing apparatus 24 may perform direct communication via the base station 50. In addition to Cellular-V2X and DSRC (registered trademark), any direct communication scheme such as Bluetooth (registered trademark) may be adopted as direct communication. The information processing apparatus 24 of a vehicle 20 may directly communicate with the terminal 82 and the information processing apparatus 24 of another vehicle 20 by using a communication infrastructure provided in Intelligent Transport Systems (ITS).

It should be noted that, in this embodiment, for ease-to-understand explanation, a case will be considered in which it is determined whether a pedestrian is present within the risk area. The pedestrian refers to a person who can pass on a road by means of a method other than a vehicle. The pedestrian includes a person who passes on a road by means of a wheelchair or the like. However, it may be determined whether not only the pedestrian but also any moving object such as a person other than the pedestrian or another vehicle is present within the risk area. The person other than the pedestrian may include a person who is in a stopped vehicle.

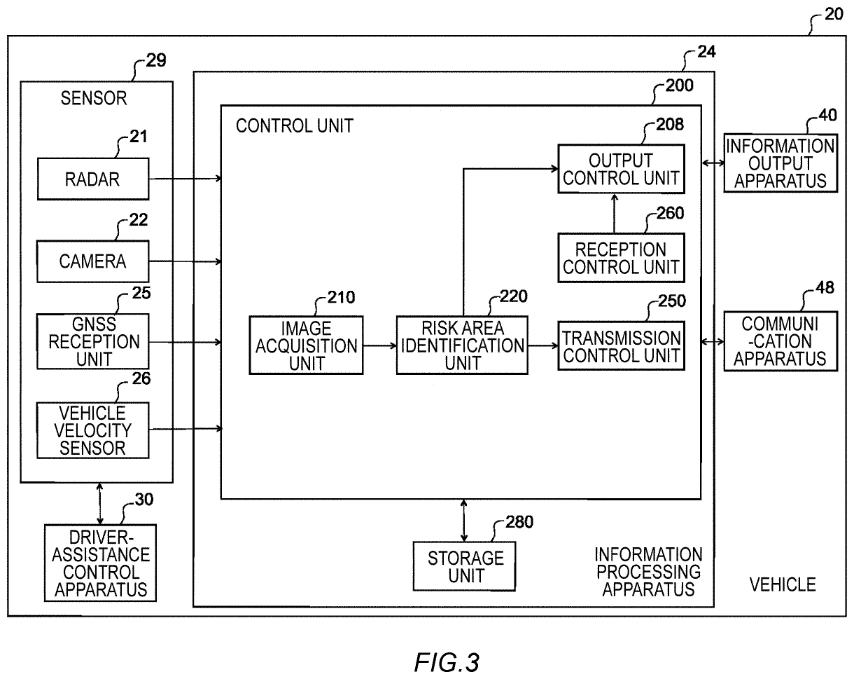

FIG. 3 shows a system configuration of the vehicle 20. The vehicle 20 includes a sensor 29, a driver-assistance control apparatus 30, an information processing apparatus 24, a communication apparatus 48, and an information output apparatus 40.

The sensor 29 includes a radar 21, a camera 22, a GNSS reception unit 25, and a vehicle velocity sensor 26. The radar 21 may be LiDAR, a millimeter-wave radar, or the like. The GNSS reception unit 25 receives a radio wave transmitted from a Global Navigation Satellite System (GNSS) satellite. The GNSS reception unit 25 generates information indicating a current position of the vehicle 20 based on a signal received from the GNSS satellite. The camera 22 is one example of an image-capturing unit mounted on the vehicle 20. The camera 22 captures an image around the vehicle 20 to generate image information. For example, the camera 22 captures an image in an advancing direction of the vehicle 20 to generate image information. The camera 22 may be a monocular camera. The camera 22 may be a compound-eye camera, and may be able to acquire information on a distance to an object. It should be noted that the sensor 29 may include a position sensor such as an odometer, or an Inertial Measurement Unit (IMU) such as an acceleration sensor or an attitude sensor.

The driver-assistance control apparatus 30 performs driver-assistance of the vehicle 20 by using information detected by the sensor 29. The driver-assistance control apparatus 30 may be realized by an ECU having a function of an Advanced Driver-Assistance Systems (ADAS).

The communication apparatus 48 is responsible for direct communication with the terminal 82 and another vehicle 20. For example, the communication apparatus 48 is responsible for wireless communication by PC5.

The information output apparatus 40 outputs alarm information. The information output apparatus 40 may have a Human Machine Interface (HMI) function. The information output apparatus 40 may include a head-up display and a navigation system. The information output apparatus 40 may be a mobile terminal possessed by the occupant of the vehicle 20. The information output apparatus 40 may include a voice output apparatus that outputs the alarm information by a voice.

The information processing apparatus 24 includes a control unit 200 and a storage unit 280. The control unit 200 is realized, for example, by a circuit of an arithmetic processing apparatus or the like including a processor. The storage unit 280 is realized by including a non-volatile storage medium. The control unit 200 performs processing by using information stored in the storage unit 280. The control unit 200 may be realized by Electronic Control Unit (ECU) including a microcomputer provided with CPU, ROM, RAM, I/O, a bus, and the like.

The control unit 200 includes an image acquisition unit 210, a risk area identification unit 220, an output control unit 208, a transmission control unit 250, and a reception control unit 260. It should be noted that a functional configuration of the control unit 200 shown in FIG. 3 may be responsible for functional parts of the respective information processing apparatuses 24 of the vehicles 20 described in relation to FIG. 1 and FIG. 2. It should be noted that a form may be adopted in which the control unit 200 does not have some functions of functional blocks shown in FIG. 3. For example, a form may be adopted in which only some functions are implemented in the control unit 200 while the other functions are implemented as functions of the sensor 29 or another circuit.

The image acquisition unit 210 acquires image information of the exterior of the vehicle 20. The image acquisition unit 210 acquires an image from the camera 22 placed in the vehicle 20.

The risk area identification unit 220 identifies a risk area outside the vehicle 20. For example, the risk area identification unit 220 identifies a risk area outside the vehicle 20 with respect to movement of the vehicle 20 based on an image photographed by the camera 22. For example, the risk area identification unit 220 identifies an area invisible from a position of the vehicle 20 as the risk area. The risk area identification unit 220 judges the invisible area by recognizing a target object from the image captured by the camera 22.

It should be noted that the invisible area is, for example, position information of an area where occlusion is generated, when viewed from the position of the vehicle 20, due to shielding by a three-dimensional object such as another stopped vehicle, a building, a roadside tree. The risk area identification unit 220 judges invisibility by recognizing a particular three-dimensional object from the image. The risk area identification unit 220 may identify an invisible area based on image information and map information. The risk area identification unit 220 may receive position information of the invisible area sent from another vehicle 20 or the server 52, and may identify the invisible area based on the received position information of the invisible area.

Transmission control unit 250 controls sending risk area information indicating the risk area identified by the risk area identification unit 220 to the server 52 that retains information indicating the risk area.

It should be noted that the transmission control unit 250 may control sending the position information of the risk area without specifying a destination. For example, the transmission control unit 250 may control sending a plurality of latitude/longitude coordinates of the risk area without specifying a destination. It should be noted that the position information of the risk area may be a plurality of pieces of coordinate information of the risk area. The position information of the risk area may be a plurality of pieces of coordinate information indicating a range of the risk area. When the risk area is polygonal, the plurality of pieces of coordinate information may be coordinate information of vertices of the polygon. The position information of the risk area may include coordinate information, and information on a distance from a position indicated by that coordinate information. For example, it may include coordinate information of a particular point in the risk area, and distance information representing a size of the risk area with that point as a reference. The position information of the risk area may be latitude/longitude coordinate information representing a geographic position of the risk area. The transmission control unit 250 may send the risk area information by broadcasting.

It should be noted that, in this embodiment, “transmission is performed to the exterior of the vehicle 20” under control of the transmission control unit 250 may mean “transmission is performed, by broadcasting, to a peripheral communication device without specifying a destination”. Also, “without specifying a destination” means “without specifying a destination under control of the transmission control unit 250”, and transmission may be transferred by another apparatus/terminal that has received that transmission, where a destination may be specified by the other apparatus/terminal. “Transmission is performed to the exterior of the vehicle 20” may mean “transmission is performed in a manner that, regardless of whether the sent information can be received by the communication device within the vehicle 20, the sent information can be received by a communication device outside the vehicle 20”.

The reception control unit 260 controls receiving information indicating a risk area retained in the server 52 in relation to a planned traveling route of the vehicle 20. When the risk area identification unit 220 could not identify, on the planned traveling route, the risk area indicated by the information received from the server 52, the transmission control unit 250 controls sending evaluation information regarding evaluation of the risk area indicated by the information received from the server 52.

The evaluation information may be information for instructing the server 52 to delete the information indicating the risk area retained in the server 52 in relation to the planned traveling route. The evaluation information may be information for instructing the server 52 to lower an evaluation value of the information indicating the risk area retained in the server 52 in relation to the planned traveling route.

The reception control unit 260 controls further receiving identification information of the risk area retained in the server 52 in relation to the planned traveling route. The transmission control unit 250 controls sending the evaluation information in association with that identification information.

Information indicating a reliability value of the risk area identified by the risk area identification unit 220 is preset in the vehicle 20. For example, a reliability value corresponding to performance of in-vehicle equipment involved in the identification of the risk area may be preset in the control unit 200 of the vehicle 20. The reliability value may be preset according to presence/absence of the camera 22, the radar 21, and the GNSS reception unit 25. The reliability value may be preset according to performance of the camera 22, performance of the radar 21, and performance of the GNSS reception unit 25. The transmission control unit 250 controls sending the evaluation information along with the information indicating the reliability value.

The output control unit 208 controls execution of driver-assistance of the vehicle 20 or warning to the occupant of the vehicle 20. For example, when the information output apparatus 40 includes a head-up display, the output control unit 208 may cause a head-up display of the vehicle 20a to output light for forming a mark serving as alarm information indicating presence of a pedestrian in the risk area. Also, the output control unit 208 causes the head-up display to output light for forming a mark in a display region corresponding to a position of the risk area where the pedestrian is present. The output control unit 208 may project light for forming a mark to a reflecting member provided in a windshield of the vehicle 20. It should be noted that the output control unit 208 may output the alarm information by a voice or a text. The output control unit 208 may control traveling of the vehicle 20 through the driver-assistance control apparatus 30.

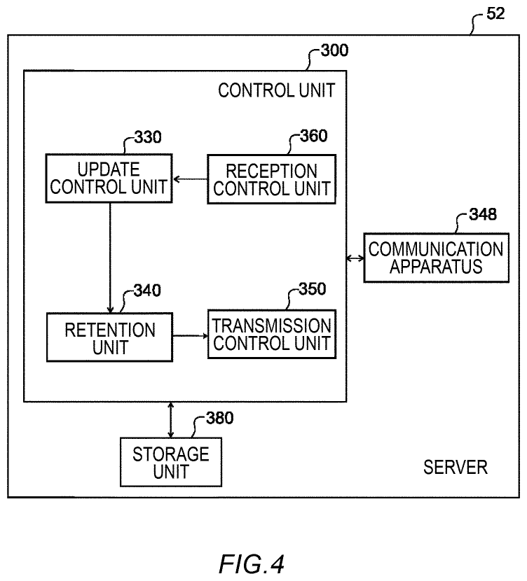

FIG. 4 shows a system configuration of the server 52. The server 52 includes a communication apparatus 348, a control unit 300, and a storage unit 380.

The control unit 300 controls the communication apparatus 348. The communication apparatus 348 is responsible for communication with the terminal 82 and the information processing apparatus 24. The control unit 200 is realized, for example, by a circuit of an arithmetic processing apparatus or the like including a processor. The storage unit 380 is realized by including a non-volatile storage medium. The control unit 300 performs processing by using information stored in the storage unit 380. The control unit 300 may be realized by a microcomputer provided with CPU, ROM, RAM, I/O, a bus, and the like.

The control unit 300 includes an update control unit 330, a retention unit 340, a transmission control unit 350, and a reception control unit 360. It should be noted that a form may be adopted in which the control unit 300 does not have some functions of functional blocks shown in FIG. 4.

The retention unit 340 retains information indicating a risk area identified in the vehicle 20 and an evaluation value of the information indicating the risk area. The retention unit 340 retains, in cooperation with the storage unit 380, risk area management information including the information indicating the risk area and the evaluation value of the information indicating the risk area. The retention unit 340 and the storage unit 380 may function as a database system in which data can be added, updated, and deleted.

The transmission control unit 350 controls sending, to another vehicle 20, the information indicating the risk area retained by the retention unit 340 in relation to a planned traveling route of another vehicle 20. The reception control unit 360 controls receiving, from another vehicle 20, evaluation information regarding evaluation of the risk area. The update control unit 330 updates the evaluation value based on the received evaluation information.

The evaluation value may be information indicating a reliability degree as the risk area. The evaluation value may be information indicating an unreliability degree as the risk area.

The update control unit 330 updates, based on the evaluation information, the evaluation value retained by the retention unit 340, and if the evaluation value updated based on the evaluation information has become lower than a predetermined threshold value, the update control unit 330 causes the information indicating the risk area retained by the retention unit 340 to be deleted.

The retention unit 340 further retains the threshold value in association with the risk area. If the evaluation value updated based on the evaluation information has become lower than the threshold value associated with the risk area, the update control unit 330 deletes the information indicating the risk area retained by the retention unit 340.

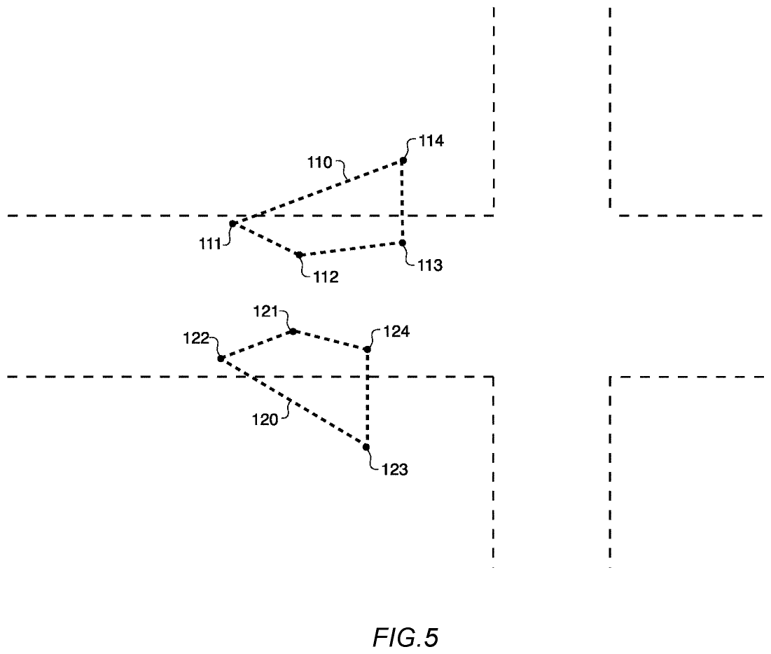

FIG. 5 conceptually shows position information of a risk area managed by an information processing apparatus 24a. Here, a case is shown in which the invisible areas 110 and 120 identified by the area identification unit 220 are set as risk areas.

In the vehicle 20a, respective coordinates of four points 111, 112, 113, and 114 representing a contour of the area 110 are calculated. The area 110 is a closed region formed by linking the coordinates of the point 111, the point 112, the point 113, and the point 114. Also, the information processing apparatus 24a calculates respective coordinates of four points 121, 122, 123, and 124 representing a contour of the area 120. The area 120 is a closed region formed by linking the point 121, the point 122, the point 123, and the point 124. The information processing apparatus 24a stores the respective coordinates of the point 111, the point 112, the point 113, and the point 114 in association with an area ID given to the area 110. Also, the information processing apparatus 24a stores the respective coordinates of the point 121, the point 122, the point 123, and the point 124 in association with an area ID given to the area 120. Then, the transmission control unit 250 sends risk area information including the area ID as well as the coordinates indicating the area 110 and the area 120.

When the vehicle 20d has received the risk area information, the information processing apparatus 24d analyzes an image region including an area surrounded by the four points indicated by the coordinates included in the risk area information from an image acquired by a camera mounted on the vehicle 20d, and detects a pedestrian who is present within a predetermined range including that area. The information processing apparatus 24d sends, to the vehicle 20a having sent the risk area information, response information including: a pedestrian detection result within the area surrounded by the four points and the area ID; position information of the detected pedestrian; and accuracy information of that position information.

When the camera system 60 has received the risk area information, the camera system 60 analyzes an image region including an area surrounded by the four points indicated by the coordinates included in the risk area information from an image acquired by an image-capturing function of the camera system 60, and detects a pedestrian who is present within a predetermined range including that area. The camera system 60 sends, to the vehicle 20a having sent the risk area information, response information including: a pedestrian detection result within the area surrounded by the four points and the area ID; position information of the detected pedestrian; and accuracy information of that position information.

When the terminal 82 has received the risk area information, the terminal 82 acquires current position information of the terminal 82. The terminal 82 sends, to the vehicle 20a having sent the risk area information, response information including the current position information of the terminal 82 and accuracy information of the position information. Also, the terminal 82 may determine whether the current position of the terminal 82 is included in an area within the predetermined range including the area surrounded by the four points indicated by the coordinates included in the risk area information, and when the current position of the terminal 82 is included in that area within the predetermined range including the area surrounded by the four points, the terminal 82 may output an alarm to the pedestrian 80.

It should be noted that, when the risk area is circular, the position information of the risk area may include coordinate information of a central point of the risk area and diameter information of the risk area. When the risk area is polygonal, the position information of the risk area may include coordinate information of a point corresponding to a reference of the polygon and side length information such as a width and a height of the risk area. When the risk area is elliptical, the position information of the risk area may include coordinate information of a central point of the risk area as well as major axis, minor axis, and azimuth angle information.

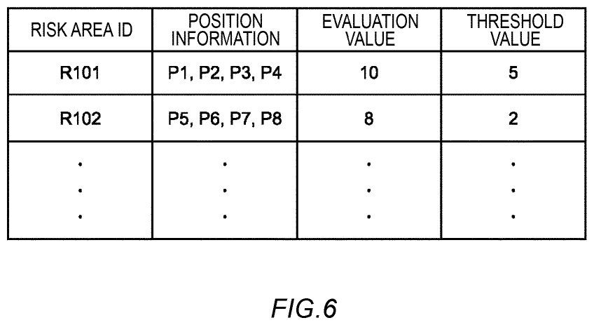

FIG. 6 shows, in a table form, a data structure of the risk area management information retained by the retention unit 340. The risk area management information includes a risk area ID, position information, an evaluation value, and a threshold value.

The risk area ID is identification information of a risk area. When sending position information of the risk area to the vehicle 20, the transmission control unit 350 causes the identification information stored in the risk area management information to be sent along with the position information of the risk area.

The position information is information indicating a position of the risk area. The position information may be geographic coordinate information of a plurality of vertices of the risk area. In the example of FIG. 6, the position information includes coordinate information of four vertices of the risk area. When the position of the risk area is identified with a rectangle, the position information may include position information of two diagonal vertices of the rectangle. The position information may store coordinate information included in the risk area information received by the server 52 from the information processing apparatus 24.

The evaluation value is information indicating the reliability degree of the risk area. The update control unit 330 updates the evaluation value of the risk area management information according to the evaluation information received from the vehicle 20. In this embodiment, the evaluation value represents the reliability degree of the risk area. Therefore, the higher the evaluation value is, the higher the reliability degree is. In another embodiment, the evaluation value may represent the unreliability degree of the risk area. In this case, the higher the evaluation value is, the lower the reliability degree is.

The threshold value is a reference value used to determine whether to delete the risk area from the risk area management information. If an evaluation value associated with the risk area has become less than the threshold value, the update control unit 330 causes corresponding risk area information to be deleted. For example, if an evaluation value associated with a risk area ID “R101” has become less than a threshold value “5”, the update control unit 330 causes information associated with the risk area ID “R101” to be deleted from the risk area management information retained in the retention unit 340.

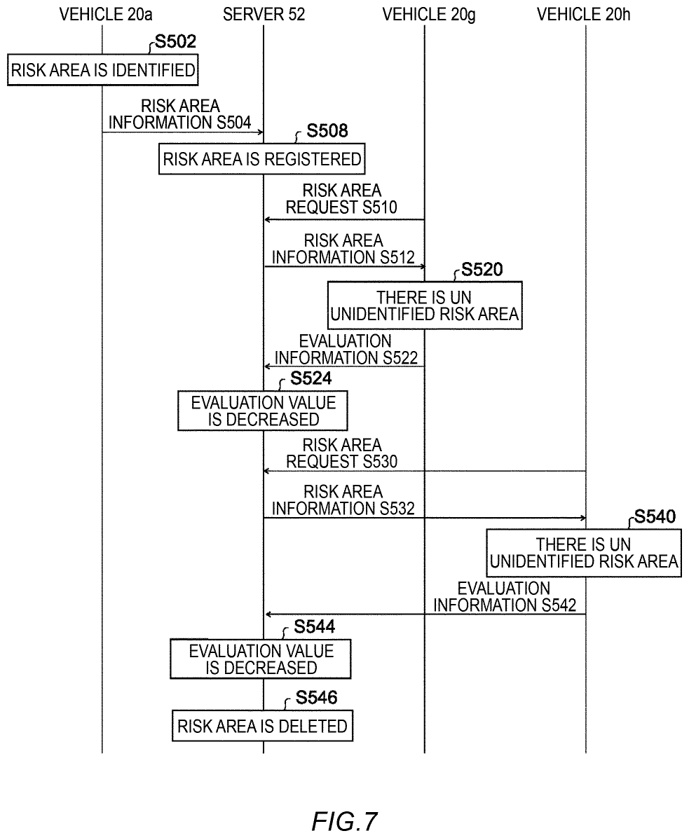

FIG. 7 schematically shows a flow of processing executed by the vehicle 20a, the vehicle 20g, the vehicle 20h, and the server 52.

In the vehicle 20a, the risk area identification unit 220 identifies risk areas (S502). When the risk area identification unit 220 has identified the risk areas, in S504, the transmission control unit 250 sends risk area information. In this case, the transmission control unit 250 may send the risk area information without specifying a destination. The risk area information includes position information of the risk areas identified by the risk area identification unit 220. For example, it includes coordinate information of the area 110.

In S508, the retention unit 340 registers the risk areas indicated by the received risk area information. Specifically, the retention unit 340 adds, to risk area management information, data including coordinate information of the risk areas included in the received risk area information. It should be noted that, when registering a new risk area, the retention unit 340 may set an evaluation value retained in the risk area management information to a predetermined defined value. When registering a new risk area, the retention unit 340 may set a threshold value retained in the risk area management information to a predetermined defined value.

Subsequently, in S510, the information processing apparatus 24g of the vehicle 20g sends, to the server 52, a risk area request for requesting the risk area information. For example, the information processing apparatus 24g of the vehicle 20g requests the server 52 for risk area information on a planned traveling route of the vehicle 20g.

In S512, the server 52 sends the risk area information to the information processing apparatus 24g. The risk area information sent to the information processing apparatus 24g includes, for example, coordinate information and a risk area ID of the area 110.

In S520, the information processing apparatus 24g of the vehicle 20g determines that there was an area that could not be identified by the risk area identification unit 220 of the information processing apparatus 24g among the risk areas indicated by the risk area information received in S512. For example, as described in relation to FIG. 2, the information processing apparatus 24g determines that the risk area was not identified within a predetermined range including the area 110. In response to this determination, the transmission control unit 250 of the information processing apparatus 24g causes evaluation information to be sent to the server 52 (S522). For example, the transmission control unit 250 of the information processing apparatus 24g causes, in association with the risk area ID corresponding to the area 110, evaluation information indicating that the area 110 could not be identified as a risk area to be sent.

In S524, the update control unit 330 of the server 52 decreases, in the risk area management information, the evaluation value retained in association with the risk area ID included in the evaluation information received in S522.

Subsequently, in S530, the information processing apparatus 24h of the vehicle 20h sends, to the server 52, a risk area request for requesting risk area information. For example, the information processing apparatus 24h of the vehicle 20h requests the server 52 for risk area information on a planned traveling route of the vehicle 20h.

In S532, the server 52 sends the risk area information to the information processing apparatus 24h. The risk area information sent to the information processing apparatus 24h includes, for example, coordinate information and a risk area ID of the area 110.

In S540, the information processing apparatus 24h of the vehicle 20h determines that there was an area that could not be identified by the risk area identification unit 220 of the information processing apparatus 24h among the risk areas indicated by the risk area information received in S532. For example, as described in relation to FIG. 2, the information processing apparatus 24h determines that the risk area was not identified within a predetermined range including the area 110. In response to this determination, the transmission control unit 250 of the information processing apparatus 24h causes evaluation information to be sent to the server 52 (S542). For example, the transmission control unit 250 of the information processing apparatus 24h causes, in association with the risk area ID corresponding to the area 110, evaluation information indicating that the area 110 could not be identified as a risk area to be sent.

In S544, the update control unit 330 of the server 52 decreases, in the risk area management information, the evaluation value retained in association with the risk area ID included in the evaluation information received in S542.

In S546, the update control unit 330 deletes the risk area when the evaluation value has become less than the threshold value due to the decrease in the evaluation value in S544.

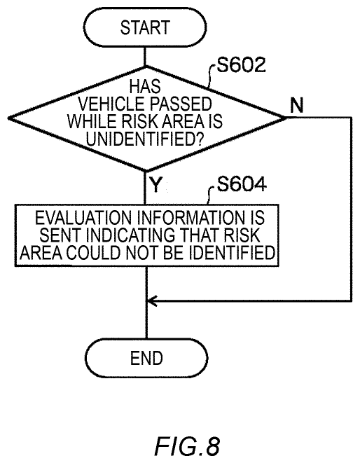

FIG. 8 is a flowchart showing a processing procedure executed by an information processing apparatus 24 of the vehicle 20. When the vehicle 20 has passed a position of at least one area of the risk areas received from the server 52, the processing of FIG. 8 is executed with that area as a target area. The processing of FIG. 8 corresponds to S520, S522, S540, and S542 of FIG. 7. Here, among the risk areas received from the server 52, an area targeted for the processing of FIG. 8 is referred to as “target area”.

In S602, the risk area identification unit 220 determines whether the vehicle 20 has passed without the risk area identification unit 220 identifying the target area as a risk area. For example, the risk area identification unit 220 determines whether the risk area could not be identified within a predetermined range including the target area. If it is determined that the target area was identified as the risk area, the processing ends.

If it is determined that the vehicle 20 has passed without identification of the target area as the risk area, in S604, evaluation information indicating that the target area could not be identified as the risk area is sent to the server 52. At this time, the transmission control unit 250 sends the evaluation information in association with a risk area ID of the target area. Specifically, the transmission control unit 250 sends the evaluation information along with the risk area ID of the target area. Also, the transmission control unit 250 sends the evaluation information along with a reliability value set in the vehicle 20. When S604 is completed, the processing ends.

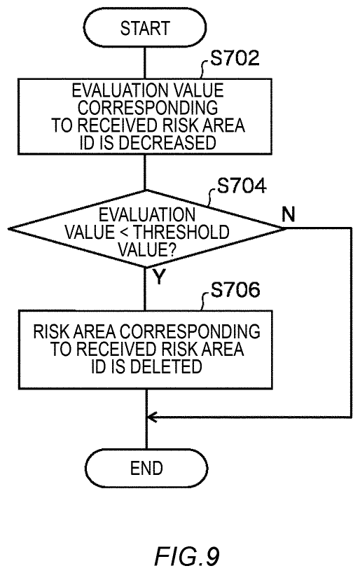

FIG. 9 is a flowchart showing a processing procedure executed by the server 52. When evaluation information has been received from the information processing apparatus 24, the processing of FIG. 9 starts. The processing of FIG. 9 corresponds to the processing of S524, S544, and S546.

In S702, the update control unit 330 decreases, in risk area management information, an evaluation value corresponding to a risk area ID associated with the evaluation information. For example, the update control unit 330 decreases the evaluation value according to a reliability value received along with the evaluation information. Specifically, the update control unit 330 may decrease more significantly the evaluation value as the reliability value received along with the evaluation information is greater.

In S704, the update control unit 330 determines whether the evaluation value decreased in S702 has become less than a threshold value. For example, the update control unit 330 determines whether the evaluation value decreased in S702 has become less than a threshold value corresponding to the risk area ID associated with the received evaluation information. If the evaluation value is equal to or greater than the threshold value, the processing ends.

If the evaluation value has become less than the threshold value, in S706, the update control unit 330 deletes information corresponding to the risk area ID associated with the received evaluation information. For example, the update control unit 330 deletes the information corresponding to the risk area ID from the risk area management information retained by the retention unit 340.

It should be noted that, if the update control unit 330 has received risk area information from the vehicle 20, when determining, based on position information included in the risk area information received from the vehicle 20 and position information retained in the risk area management information, a risk area indicated by the received risk area information corresponds to a risk area already retained by the retention unit 340, the update control unit 330 may increase an evaluation value corresponding to that corresponding risk area. When determining that the risk area indicated by the risk area information received from the vehicle 20 corresponds to the risk area already retained by the retention unit 340, the update control unit 330 may set the evaluation value corresponding to that corresponding risk area to a defined value. When determining that the risk area indicated by the risk area information received from the vehicle 20 corresponds to the risk area already retained by the retention unit 340, the update control unit 330 may set the evaluation value corresponding to that corresponding risk area to a defined value on condition that a reliability degree of the vehicle 20 is higher than a predetermined value.

The system 10 described above allows the server 52 to respond to a change in the risk area, even when the risk area has changed over time such as due to movement of a vehicle that had caused a risk in the risk area. This allows provision of highly reliable risk area information to the vehicle 20.

It should be noted that a form may be adopted in which the camera system 60 includes a function provided in the information processing apparatus 24.

It should be noted that the vehicle 20 is one example of transportation equipment. The transportation equipment includes, for example, an automobile such as a passenger vehicle or a bus, a saddle-ride type vehicle, and a bicycle. Also, a moving object includes not only a person but also transportation equipment, for example, an automobile such as a passenger vehicle or a bus, a saddle-ride type vehicle, and a bicycle.

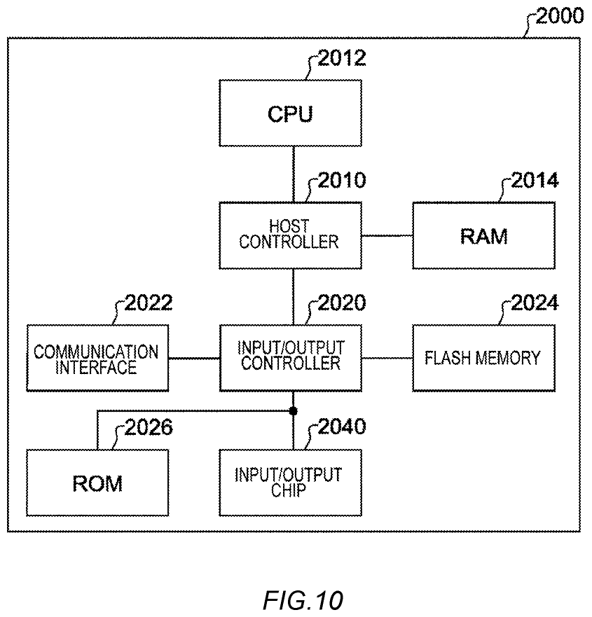

FIG. 10 shows an example of a computer 2000 in which a plurality of embodiments of the present invention may be entirely or partly embodied. A program installed on the computer 2000 can cause the computer 2000: to function as a system such as the server according to the embodiments or each unit of that system or as an information processing apparatus or each unit thereof; to execute an operation correlated with that system or each unit thereof or with that apparatus or each unit thereof; and/or to execute a process according to the embodiments or a stage of that process. Such a program may be executed by a CPU 2012 in order to cause the computer 2000 to execute a specific operation correlated with some or all of the blocks in the processing procedure and the block diagram described in this specification.

The computer 2000 according to this embodiment includes the CPU 2012 and RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to a program stored within the ROM 2026 and the RAM 2014, thereby controlling each unit.

The communication interface 2022 communicates with other electronic devices via a network. The flash memory 2024 stores programs and data used by the CPU 2012 within the computer 2000. The ROM 2026 stores a boot program or the like that is executed by the computer 2000 during activation, and/or a program that depends on hardware of the computer 2000. The input/output chip 2040 may also connect various input/output units such as a keyboard, a mouse, and a monitor, to the input/output controller 2020 via an input/output port such as a serial port, a parallel port, a keyboard port, a mouse port, a monitor port, a USB port, an HDMI (registered trademark) port.

The programs are provided via a computer-readable storage medium such as CD-ROM, DVD-ROM, or a memory card, or a network. The RAM 2014, the ROM 2026, or the flash memory 2024 is an example of the computer-readable storage medium. The programs are installed in the flash memory 2024, the RAM 2014, or the ROM 2026, and are executed by the CPU 2012. Information processing written within these programs is read by the computer 2000, resulting in cooperation between the programs and the above various types of hardware resources. An apparatus or a method may be constituted by realizing an operation or processing on information according to a use of the computer 2000.

For example, when communication is executed between the computer 2000 and an external device, the CPU 2012 may execute a communication program loaded in the RAM 2014, and may instruct the communication interface 2022 to perform communication processing based on processing written in the communication program. Under control of the CPU 2012, the communication interface 2022 reads transmission data stored in a transmission buffer processing region provided within a recording medium such as the RAM 2014 and the flash memory 2024, sends the read transmission data to the network, and writes reception data received from the network into a reception buffer processing region or the like provided on the recording medium.

Also, the CPU 2012 may cause all or required portions of a file or a database stored in the recording medium such as the flash memory 2024 or the like to be read by the RAM 2014, and may execute various kinds of processing on the data on the RAM 2014. Next, the CPU 2012 writes back the processed data into the recording medium.

Various types of programs and various types of information such as data, a table, and a database may be stored in the recording medium, and may be subjected to information processing. The CPU 2012 may execute, on the data read from the RAM 2014, various kinds of processing including various kinds of operations, information processing, conditional judgment, conditional branching, unconditional branching, information retrieval/replacement, or the like that are described in this specification and specified by instruction sequences of the programs, and writes back a result into the RAM 2014. Also, the CPU 2012 may retrieve information in a file, a database, or the like within the recording medium. For example, when a plurality of entries are stored within the recording medium, each entry having an attribute value of a first attribute correlated with an attribute value of a second attribute, the CPU 2012 may retrieve, from the plurality of entries, an entry whose attribute value of the first attribute is specified and that matches a condition, and may read the attribute value of the second attribute stored within the entry, thereby acquiring the attribute value of the second attribute correlated with the first attribute that satisfies a predetermined condition.

The programs described above or a software module may be stored in a computer-readable storage medium on or near the computer 2000. A recording medium such as a hard disk or RAM provided within a server system connected to a dedicated communication network or the Internet can be used as a computer-readable storage medium. The programs stored in the computer-readable storage medium may be provided to the computer 2000 via the network.

The programs installed in the computer 2000 and causing the computer 2000 to function as the information processing apparatus 24 may instruct the CPU 2012 or the like to cause the computer 2000 to function as each unit of the information processing apparatus 24. The information processing written in these programs are read by the computer 2000, so that the computer functions as each unit of the information processing apparatus 24, which is a specific means realized by cooperation between software and the above various types of hardware resources. Then, these specific means realize arithmetic operation or processing of information corresponding to an intended use of the computer 2000 in this embodiment, so that the information processing apparatus 24 is constructed as a specific information processing apparatus corresponding to the intended use.

The programs installed in the computer 2000 and causing the computer 2000 to function as the server 52 may instruct the CPU 2012 or the like to cause the computer 2000 to function as each unit of the server 52. The information processing written in these programs are read by the computer 2000, so that the computer functions as each unit of the server 52, which is a specific means realized by cooperation between software and the above various types of hardware resources. Then, these specific means realize arithmetic operation or processing of information corresponding to an intended use of the computer 2000 in this embodiment, so that the server 52 is constructed as a specific server corresponding to the intended use.

Various embodiments have been described with reference to the block diagram and the like. In the block diagram, each block may represent (1) a stage of a process in which an operation is executed, or (2) each unit of an apparatus having a role of executing the operation. A specific stage and each unit may be implemented by a dedicated circuit, a programmable circuit supplied along with a computer-readable instruction stored on a computer-readable storage medium, and/or a processor supplied along with the computer-readable instruction stored on the computer-readable storage medium. The dedicated circuit may include a digital and/or analog hardware circuit, or may include an integrated circuit (IC) and/or a discrete circuit. The programmable circuit may include a reconfigurable hardware circuit including, for example: logical AND, logical OR, exclusive OR (XOR), negative AND (NAND), negative OR (NOR), and other logical operations; and a memory element such as a flip-flop, a register, a field programmable gate array (FPGA), a programmable logic array (PLA), or the like.

The computer-readable storage medium may include any tangible device that can store an instruction executed by an appropriate device, so that the computer-readable storage medium having an instruction stored thereon constitutes at least a part of an article of manufacture including an instruction that may be executed in order to provide a means to execute an operation specified in the processing procedure or the block diagram. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disk read-only memory (CD-ROM), a digital versatile disk (DVD), a Blu-ray (registered trademark) disk, a memory stick, an integrated circuit card, and the like.

The computer-readable instruction may include one of a source code or an object code written in any combination of one or more programming languages including: an assembler instruction, an instruction-set-architecture (ISA) instruction, a machine instruction, a machine dependent instruction, a microcode, a firmware instruction, state-setting data; or an object oriented programming language such as Smalltalk (registered trademark), JAVA (registered trademark), C++, or the like; and a conventional procedural programming language such as a “C” programming language or a similar programming language.

The computer-readable instruction may be provided to a general-purpose computer, a special-purpose computer, or a processor or a programmable circuit of other programmable data processing apparatus, locally or via a local area network (LAN), a wide area network (WAN) such as the internet or the like, and the computer-readable instruction may be executed in order to provide a means to execute the operation specified in the described processing procedure or block diagram. Examples of the processor include a computer processor, a processing unit, a microprocessor, a digital signal processor, a controller, a microcontroller, and the like.

While the present invention has been described above using embodiments, a technical scope of the present invention is not limited to a scope described in the above embodiments. It is apparent to persons skilled in the art that varied alteration or improvement can be added to the above embodiments. It is apparent from description of the claims that a form added with such alteration or improvement may also be included in the technical scope of the present invention.

It should be noted that each processing such as the operations, procedures, steps, and stages in the apparatus, system, program, and method shown in the claims, the specification, or the drawings may be realized in any order, unless its execution order is specified as “before”, “prior to”, or the like and unless output from previous processing is used in subsequent processing. Even if description is made, regarding an operation flow in the claims, the specification or the drawings, by using “first”, “next”, or the like as a matter of convenience, it does not necessarily mean that the processing must be performed in this order.

### EXPLANATION OF REFERENCES

10: system
20: vehicle
21: radar
22: camera
24: information processing apparatus
25: GNSS reception unit
26: vehicle velocity sensor
29: sensor
30: driver-assistance control apparatus
40: information output apparatus
48: communication apparatus
50: base station
52: server
60: camera system
70, 72: road
80: pedestrian
82: terminal
90: building
110, 120, 130: area
111, 112, 113, 114, 121, 122, 123, 124: point
200: control unit
208: output control unit
210: image acquisition unit
220: area identification unit
250: transmission control unit
260: reception control unit
280: storage unit
300: control unit
330: update control unit
340: retention unit
350: transmission control unit
360: reception control unit
348: communication apparatus
380: storage unit
2000: computer
2010: host controller
2012: CPU
2014: RAM
2020: input/output controller
2022: communication interface
2024: flash memory
2026: ROM
2040: input/output chip.

What is claimed is:

1. An information processing apparatus comprising:
a risk area identification unit configured to identify a risk area outside a moving object;
a transmission control unit configured to control sending risk area information indicating the risk area identified by the risk area identification unit to a server for retaining information indicating a risk area; and
a reception control unit configured to control receiving the information indicating the risk area retained in the server in relation to a planned traveling route of the moving object, wherein
the transmission control unit is configured to control sending evaluation information regarding evaluation of the risk area indicated by the information received from the server, when the risk area identification unit could not identify, on the planned traveling route, the risk area indicated by the information received from the server.

2. The information processing apparatus according to claim 1, wherein the evaluation information is information for instructing the server to delete the information indicating the risk area retained in the server in relation to the planned traveling route.

3. The information processing apparatus according to claim 1, wherein the evaluation information is information for instructing the server to lower an evaluation value of the information indicating the risk area retained in the server in relation to the planned traveling route.

4. The information processing apparatus according to claim 1, wherein
the reception control unit is configured to control further receiving identification information of the risk area retained in the server in relation to the planned traveling route, and
the transmission control unit is configured to control sending the evaluation information in association with the identification information.

5. The information processing apparatus according to claim 1, wherein
information indicating a reliability value of the risk area identified by the risk area identification unit is preset in the moving object, and
the transmission control unit is configured to control sending the evaluation information along with the information indicating the reliability value.

6. The information processing apparatus according to claim 1, wherein the moving object is a vehicle.

7. The information processing apparatus according to claim 2, wherein
the reception control unit is configured to control further receiving identification information of the risk area retained in the server in relation to the planned traveling route, and
the transmission control unit is configured to control sending the evaluation information in association with the identification information.

8. The information processing apparatus according to claim 3, wherein
the reception control unit is configured to control further receiving identification information of the risk area retained in the server in relation to the planned traveling route, and
the transmission control unit is configured to control sending the evaluation information in association with the identification information.

9. The information processing apparatus according to claim 2, wherein
information indicating a reliability value of the risk area identified by the risk area identification unit is preset in the moving object, and
the transmission control unit is configured to control sending the evaluation information along with the information indicating the reliability value.

10. The information processing apparatus according to claim 3, wherein
information indicating a reliability value of the risk area identified by the risk area identification unit is preset in the moving object, and
the transmission control unit is configured to control sending the evaluation information along with the information indicating the reliability value.

11. The information processing apparatus according to claim 4, wherein
information indicating a reliability value of the risk area identified by the risk area identification unit is preset in the moving object, and
the transmission control unit is configured to control sending the evaluation information along with the information indicating the reliability value.

12. A moving object comprising the information processing apparatus according to claim 1.

13. A server comprising:
a retention unit configured to retain information indicating a risk area identified in a moving object and an evaluation value of the information indicating the risk area:
a transmission control unit configured to control sending the information indicating the risk area retained by the retention unit in relation to a planned traveling route of an other moving object to the other moving object;
a reception control unit configured to control receiving evaluation information regarding evaluation of the risk area from the other moving object; and
an update control unit configured to update the evaluation value based on the evaluation information.

14. The server according to claim 13, wherein the update control unit is configured to: update, based on the evaluation information, the evaluation value retained by the retention unit; and cause the information indicating the risk area retained by the retention unit to be deleted, if the evaluation value updated based on the evaluation information has become lower than a predetermined threshold value.

15. The server according to claim 14, wherein
the retention unit is configured to further retain the threshold value in association with the risk area, and
the update control unit is configured to delete the information indicating the risk area retained by the retention unit, if the evaluation value updated based on the evaluation information has become lower than the threshold value associated with the risk area.

16. The server according to claim 13, wherein
the reception control unit is configured to control receiving, from the other moving object, the evaluation information along with a reliability value of a risk area identified in the other moving object, and
the update control unit is configured to update, according to the reliability value received along with the evaluation information, the evaluation value retained by the retention unit.

17. The server according to claim 14, wherein
the reception control unit is configured to control receiving, from the other moving object, the evaluation information along with a reliability value of a risk area identified in the other moving object, and
the update control unit is configured to update, according to the reliability value received along with the evaluation information, the evaluation value retained by the retention unit.

18. The server according to claim 16, wherein the update control unit is configured to decrease more significantly the evaluation value retained by the retention unit as the reliability value is greater.

19. The server according to claim 17, wherein the update control unit is configured to decrease more significantly the evaluation value retained by the retention unit as the reliability value is greater.

20. A method comprising:
identifying a risk area outside a moving object;
sending risk area information indicating the risk area identified in the identifying to a server for retaining information indicating a risk area; and
receiving the information indicating the risk area retained in the server in relation to a planned traveling route of the moving object, wherein
sending evaluation information regarding evaluation of the risk area indicated by the information received from the server, when the risk area indicated by the information received from the server could not be identified on the planned traveling route.
